(19) United States
(12) Patent Application Publication
(10) Pub. No.: US 2005/0066809 A1
(43) Pub. Date: Mar. 31, 2005

(54) Cartridge with pistons that can be de-aerated

(75) Inventors: Klaus-Dieter Nehren, Dormagen (DE); Christian Bressler, Frankfurt (DE)

Correspondence Address: Norris, McLaughlin & Marcus P.A., 30th Floor, 220 East 42nd Street, New York, NY, 10017, US

(73) Assignee: Heraeus Kulzer GmbH & Co. KG, Hanau (DE)

(21) Appl. No.: 10/932,485

(22) Filed: Sep. 2, 2004

(30) Foreign Application Priority Data
Sep. 10, 2003 (DE) 103 42 091.6

(51) Int. Cl. B67D 5/00

(52) U.S. Cl. 91/422

(57) ABSTRACT

A cartridge which is to receive a pasty material and has a cylindrical hollow cartridge body and a de-aeratable piston comprises a two-part piston consisting of a piston part and cover part in which the cover part seals the de-aeration path after the de-aeration.

### BACKGROUND OF THE INVENTION

The use of cartridges is customary today in many product groups. In addition to single-component and multi-component adhesive and sealing substances and printing inks, dental molding masses are also offered in plastic and aluminum cartridges.

Many of these products are damaged upon storage, in the cartridge, or only have a short service lifetime due to introduced air bubbles or diffusion through the packaging material.

The air bubbles arise in the cartridge when the piston is inserted into the cartridge opening after filling. Since the pistons must have the function of sealing to the cartridge wall, the air cushion located between the product and piston is at least partially enclosed.

In the case of moisture-sensitive products, hardening can occur at the edges of incursions of air.

In the case of products containing filling substances it is a known problem that where pastes' boundary surfaces meet air, settling of liquid components occur, which can interfere with the use of these pastes.

In particular, in the case of multi-component products for automatic mixing systems with static or dynamic mixers, air bubbles lead, in the commonly used double cartridges, to varying mixture ratios since the air bubbles under the feed pressure increasing at the beginning are first compressed and delay the application of the product. This then leads at the end, with subsiding feed pressure, to re-squeezing of the bubble-containing component. Particularly in the case of pastes fed by hand through lever function, a constantly varying mixing ratio results thereby. However, this interference also occurs in all the other hand-driven, pressure-driven, or motor-driven manual or floor-mounted devices.

An additional problem for several products is the leakage of constituents or the penetration of moisture or other components of the air.

Therefore, so that cartridges can be filled without incursions of air, efforts have been made to structure the piston so that it can be de-aerated. In EP 0 344 491, EP 0 463 991, EP 0 497 739, U.S. Pat. No. 5,400,926, DE 197 14 331, and WO 90/05096 pistons for cartridges or dispensers are mentioned which in each case ensure the de-aeration by a channel contained in the center of the piston. Notches and grooves conduct, in given cases, air to this channel. The channel is then, in an additional second step, sealed with a separate part in the form of screws or stoppers. Thereby the length of the cycle in filling is significantly increased. However, experience has shown that, depending on the consistency of the pasty mass, air bubbles are enclosed in these notches/grooves, said air bubbles thus remaining in the product area. Furthermore, these pistons delay the sealing/filling process since they are operated as two separate parts during the sealing process

The disadvantage of the increased filling effort can be eliminated by, as described in DE 23 02 364 and DE 36 35 849, the necessary stoppers already being a part of the piston and only having to seal the de-aeration channel by being pressed in after the aeration.

Another path is described in DE 100 29 799, namely, by the piston base's sealing edge facing product being so small that the air is able to escape on insertion of the piston. In order to have the necessary sealing effect during the application of the product under increased pressure, the piston contains in its interior a spreading ring that causes, through the pressure of the applicator piston, an extension of the base of the piston up to the cartridge wall.

In EP 0 301 327 the principle of the spreading ring is also used but the extension is not caused first and only by the applicator but rather there, in a second operational step, a reinforcing ring is pushed so that it is clamped onto the spreading ring which provides for an intermediate and long-term extension of the base of the piston.

In DE 42 29 558 a piston with an elastic base is mentioned whose rear edge abuts the edge of the cartridge due to its greater diameter.

If it is a matter of meeting the requirements of de-aerability and as simple and quick a processing/filling as possible, the systems discussed can, however, still not be completely satisfactory.

### SUMMARY OF THE INVENTION

In the present invention a cartridge that is to receive a pasty material and has a piston that can be de-aerated is presented to meet these requirements, where the piston consists of a piston part and a cover part in which the cover part permanently seals the de-aeration path after the de-aeration.

In this connection the term “seals permanently” means: stays closed and sealed when no directed force reverses the closing/sealing process.

### DETAILED DESCRIPTION OF THE INVENTION

The piston part as a rule tightly abuts the inner wall of the cylindrical hollow cartridge body. It is provided with a de-aeration channel which is preferably a channel lying in the center with respect to the axis. The piston part is enhanced by a cover part for a piston, said cover part facing the pasty mass. During the introduction of the piston into the cartridge body filled with pasty mass, the cover part unseals one or more sealable de-aeration openings that make possible the de-aeration through the de-aeration channel of the piston part. The cover part is preferably implemented in convex form on the side facing the pasty mass. The de-aeration openings(s) preferably form an annular opening in the area of the inner wall of the cylindrical hollow body of the cartridge. The piston cover preferably can be moved toward the piston part in the longitudinal axial direction and, in fact, so that during the sealing process the air between the piston and pasty material in the area of the inner wall of the cartridge enters the piston part through the annular de-aeration opening between the piston part and cover part and is discharged through a hole in the center of the piston part. After the de-aeration the piston part in this form of embodiment is pushed through the force of compression of the pasty mass in the direction of the cover part. In so doing, the annular de-aeration opening and the de-aeration channel in the interior of the piston part are closed.

It is advantageous if a catch mechanism provides for the cover and piston in the filled state of the cartridge no longer being able to detach from one another during the handling of the piston at a later point in time. This catch mechanism is preferably located in the vicinity of the de-aeration channel laid so as to be centered with respect to the axis. As an alternative to the catch mechanism it is also possible that the piston and cover part, for example, are connected by a screw or bayonet mechanism, which also leads to long-lasting closing of the de-aeration channel but through a movement toward the outside.

Expediently a retaining mechanism holds the opened arrangement between the piston part and cover part so that the cover part in the opened state cannot be detached entirely from the piston part. It can furthermore be advantageous if a sealing ring of elastic rubber material is introduced between the piston part and cover part around the opening of the de-aeration channel centered with respect to the axis. The sealing ring is dimensioned so that it is compressed if the piston part and cover part move toward one another. After the catching process or the long-term joining of the piston part and cover part, the ring remains compressed and thus seals off access to the de-aeration channel in addition.

A form of embodiment of the invention is explained in more detail with the aid of drawings.

### BRIEF DESCRIPTION OF THE DRAWINGS

FIG. 1 shows the piston part 2 with the de-aeration hole 5.

FIG. 2 shows the piston cover 3.

FIG. 3 shows the piston 2 and cover 3 during the de-aeration process. The arrows indicate the exit path of the air. To the right and left the cartridge 1 encircles the product 6.

FIG. 4 shows, on the piston 2, the cover 3 closed after the conclusion of the de-aeration process.

FIG. 5 shows the situation of FIGS. 1, 2, and 3 in cross-section and in plan view.

FIG. 6 shows according to FIG. 5 at which point, in given cases, the sealing ring 8 is provided.

Corresponding to the designations of the figures, the invention, in its most general form, relates to a cartridge which is to receive a pasty material and has pistons which can be de-aerated, where the piston consists of a piston part 2 and a cover part 3 in which, after the de-aeration, the cover part seals the de-aeration path (4/5).

The preferred form of embodiment of the invention thus relates to a cartridge which is to receive a pasty material 6 and has a cylindrical hollow cartridge body 1 with a de-aeratable piston consisting of, abutting the inner wall of the hollow body 1, a piston part 2 with a de-aeration channel 5 and, facing a pasty mass 6, a cover part 3 which unseals de-aeration opening(s) 4 which can be sealed for the insertion process and make possible de-aeration through the de-aeration channel 5.

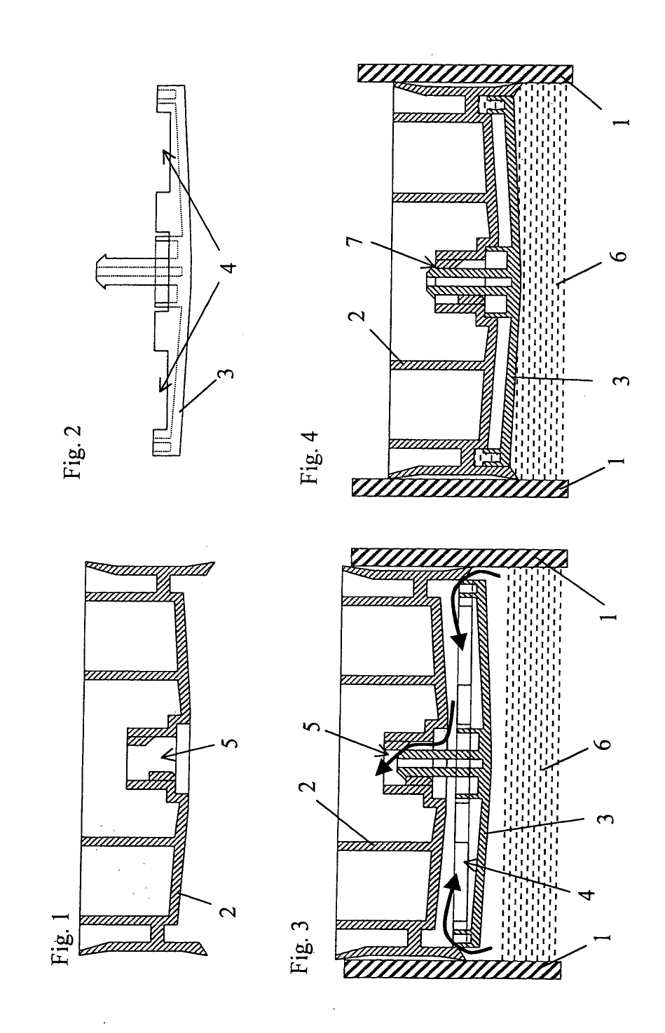

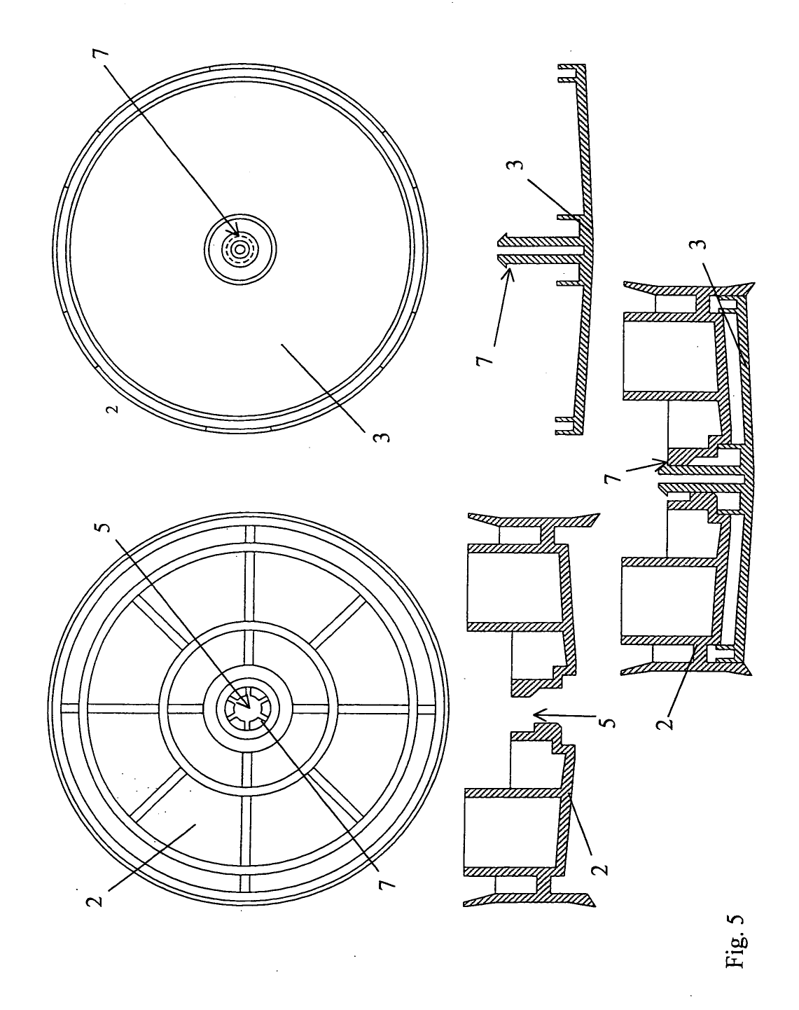

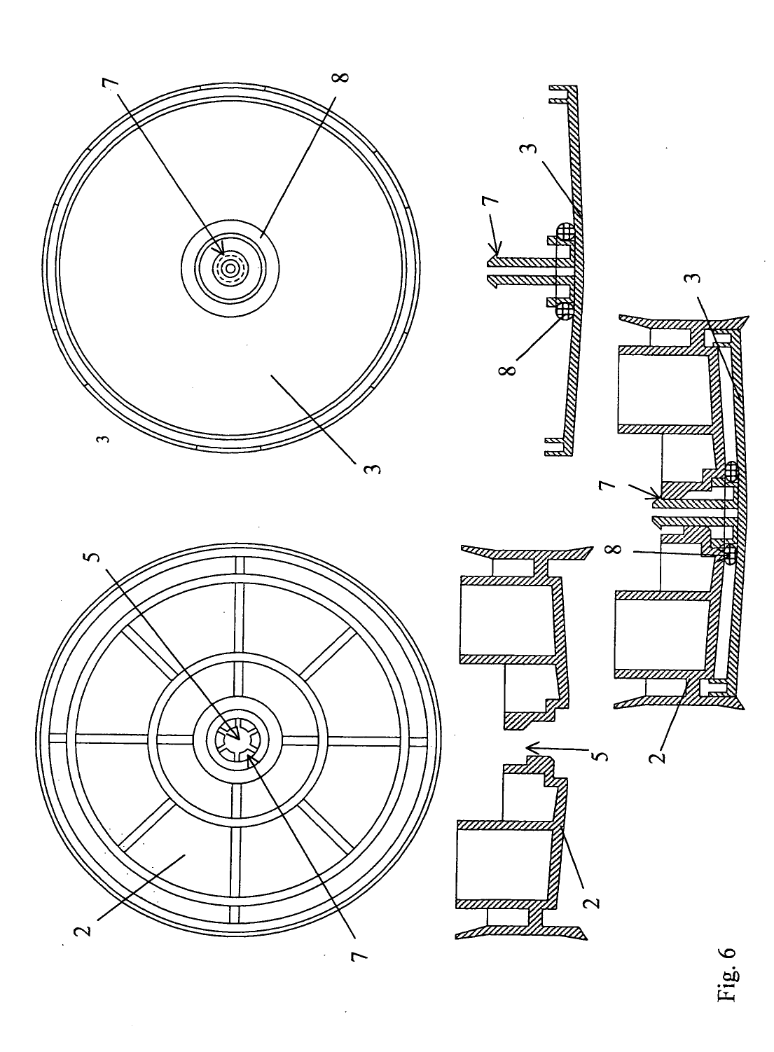

Expediently the unit of piston 2 with the pre-mounted cover 3, as shown in FIG. 3, is inserted after filling. In this pre-mounted, two-part piston however, it is also possible to insert the piston before filling and to perform the filling process from the other end of the cartridge. Preferably the cover has a convex structure on the side of the filling goods. The air is thereby driven to the edge of the piston. Annular aeration openings 4 are provided between the cover 3 and piston 2 at the edge so that the air reaches the space between the piston 2 and the cover 3 and exits through the opening 5 in the center. If the pressure at the close of the insertion procedure increases due to the fact that the cover 3 abuts almost completely de-aerated filling goods 6, the piston part 2 is moved in the direction of the cover part 3 and the aeration slots 4 as well as the outlet channel 5 are closed. One sees in FIG. 4 the state when the product 6 has pressed the piston 2 into the cover 3. Preferably a catch mechanism 7 is provided which provides for the cover 3 and piston 2 in the filled state no longer being able to detach from one another during the handling of the piston 2/3 at a later point in time. One sees the catch mechanism 7 in FIG. 2. In connection with the structure of the de-aeration hole, in FIG. 1, the cover 3 catches in the center of the piston 2. An additional catch mechanism can be provided at the edge, in the area of the product parts that appear in section to have a T-shape, which gives the cover additional support. On the other side, in FIG. 3, a retainer 9 is also represented which provides for the piston and cover part not being completely able to be removed from one another in the opened state.

Moreover, a sealing ring 8 of elastic rubber material can be provided which is compressed by the force of compression during the catching process and, in addition, tightly seals off access to the de-aeration opening 5.

1. Cartridge for pasty material (6), having a cylindrical hollow cartridge body (1) and a de-aeratable piston, said de-aeratable piston being a two-part piston comprised of a piston part (2) and cover part (3), which, when inserted into said cylindrical hollow cartridge body, define, in cooperation with the inner wall of said hollow cartridge body, a de-aeration path and wherein the cover part is adapted to permanently seal the de-aeration path after de-aeration.

2. Cartridge according to claim 1, wherein said piston part (2) comprises a de-aeration channel (5) and tightly abuts the inner wall of the hollow body (1), and said cover part (3), when said cartridge is loaded with said pasty material (6), faces the pasty material (6), and cover part (3) unseals sealable de-aeration opening(s) (4) in said de-aeration path (4/5) to enable de-aeration through the de-aeration channel (5).

3. Cartridge according to claim 1 wherein the cover part (3) is convex shaped on the side facing the portion of the cartridge where said pasty mass (6) is or is to be located, and the de-aeration openings(s) (4) are formed as an annular opening in the area of the inner wall of the hollow body (1).

4. Cartridge according to claim 1 wherein said cover part (3) is mounted on the piston part (2) and is movable in the direction toward the piston part (2) so that during a filling with pasty material (6) the air in the area of the inner wall of the cartridge enters the piston part (2) through the annular de-aeration opening (4) between the piston part (2) and cover part (3) and is discharged through a de-aeration channel (5) in the center of the piston part (2) and, after the de-aeration, the piston part (2) is pushed through the force of compression of the pasty material (6) in the direction of the cover part (3) whereby the annular de-aeration opening (4) and the de-aeration channel (5) are closed.

5. Cartridge according to claim 1 further comprising a catch mechanism (7) for cover part (3) and piston part (2) whereby, following filling and de-aeration, said cover part (3) and piston part (2) become held together.

6. Cartridge according to claim 1, wherein a sealing ring (8) of elastic rubber material is mounted between the piston part (2) and cover part (3) in the vicinity of the de-aeration channel (5) and is compressed by the force of compression when said piston part 2 and cover part 3 become held together by said catch mechanism 7, whereby de-aeration channel (5) is sealed.
